(19) United States
(12) Patent Application Publication
(10) Pub. No.: US 2011/0297605 A1
(43) Pub. Date: Dec. 8, 2011

(54) Cyclone

(76) Inventor: Donald R. Ross, Fort Wayne, IN (US)

(21) Appl. No.: 13/151,776

(22) Filed: Jun. 2, 2011

Related U.S. Application Data
(60) Provisional application No. 61/351,124, filed on Jun. 3, 2010.

(51) Int. Cl. B04C 7/00

(52) U.S. Cl. 210/232

(57) ABSTRACT

A cyclone assembly has a modular body formed from a plurality of releasably coupled body portions. A chamber is defined by and extends between the ends of the modular body. A vortex finder is releasably coupled to a first end of the modular body, and an apex is releasably coupled to the second (opposite) end of the body. The vortex finder, apex and individual body portions may be individually repaired or replaced, as needed.

### RELATED APPLICATIONS

The present application is a utility patent application which is related to and claims priority to U.S. Provisional Patent Application No. 61/351,124 filed Jun. 3, 2010, entitled Cyclone. The subject matter disclosed in said provisional application is hereby expressly incorporated into the present application.

### FIELD OF THE INVENTION

This disclosure relates generally to cyclones of the type used for separating particulate impurities from a fluid stream. More particularly, the disclosure relates to a cyclone of modular design which is particularly well suited for removing solid impurities from a highly caustic flow of fluid, such as a high pH liquid solution.

### BACKGROUND

In general, a cyclone of the type to which this disclosure relates consists of an elongated chamber, a portion of which has a generally cylindrical form. The cylindrical portion of the chamber receives a flow of contaminated fluid from one or more inlets. The inlets direct the fluid tangentially to a center line of the chamber so as to create a whirl within the chamber. The chamber also has a conical portion, adjacent the cylindrical portion, which merges at its wide end with the cylindrical portion. Clean fluid is withdrawn from the center of the cylindrical and/or conical portions by means of an outlet tube, generally referred to as a vortex finder, which projects axially into the chamber. Impurities are withdrawn from an opening formed at the apex of the conical portion.

In operation, a stream of fluid is directed under pressure through the inlet(s) into the chamber at relatively high velocity which causes the fluid to whirl rapidly within the chamber. Centrifugal forces cause outward migration of particulate impurities, depending on their specific gravity, shape, and dimensions. Impurities susceptible to segregation by centrifugal forces are thrown outwardly against the wall of the chamber and ultimately collect in the apex end of the conical portion where they are discharged through an opening in the apex. As the flow approaches the apex end of the conical portion, fluid flows inwardly toward the center and out through the vortex finder tube.

Fluid flows which are highly caustic and/or contain highly abrasive particulate impurities cause significant wear on the internal surfaces of the cyclone. To combat such wear, liners of various types have been used to protect the inner surfaces of the cyclone chamber. However, such liners may be expensive to install and maintain. Moreover, the presence of liners may make disassembly for cleaning and maintenance purposes more difficult.

There exists a need for a cyclone assembly which is relatively inexpensive to manufacture, maintain and operate, while also being resistant to wear under extreme conditions. A need further exists for a cyclone assembly which may be used individually, or used in plural combinations to efficiently remove impurities from a fluid stream.

### SUMMARY OF THE INVENTION

One embodiment of the invention comprises a modular cyclone assembly having a modular body formed from a plurality of releasably coupled body portions. The modular body has first and second ends and defines a chamber extending between the first and second ends. A first body portion defines a first chamber portion which extends between first and second ends of the first body portion. At least a portion of the first chamber portion has a generally cylindrical cross-section. One or more additional body portions are releasably coupled to the second end of the first body portion. The additional portions define a second chamber portion which communicates with the first chamber portion. At least a portion of this second chamber portion has a generally conical cross-section.

The modular cyclone assembly further includes a vortex finder releasably coupled to the first end of the modular body and extending into the generally cylindrical portion of the first chamber portion. An apex is releasably coupled to the second end of the modular body. The apex defines a generally conical bore therethrough which communicates with the second chamber portion to effectively extend the generally conical cross-section of the second chamber portion to the second end of the modular body. An inlet is formed in the modular body and communicates with the generally cylindrical portion of the first chamber portion. An outlet extends through a tubular portion of the vortex finder.

In one particular embodiment, the modular body of the modular cyclone assembly is formed from three body portions. Each of these three body portions is provided with threads on one or both ends thereof so that the body portions can be releasably and serially coupled (i.e., threaded together in-line to form the modular body).

In this and other embodiments, a cavity is formed at the second end of the modular body for receiving the apex. An apex holder is provided for releasably coupling the apex to the second end of the modular body. In a preferred embodiment, the apex holder comprises a threaded sleeve.

In certain embodiments, a first portion of the first chamber portion defined by the first body portion has a generally cylindrical cross-section, and a second portion of the first chamber portion has a generally conical cross-section.

In certain embodiments, the modular body portions are formed from a thermoplastic polymer, such as polytetrafluoroethylene. In these and/or other embodiments, the apex is formed of a ceramic material. The tubular portion of the vortex finder is, in certain embodiments, also formed of a ceramic material.

Other embodiments comprise a cyclone assembly having a first body portion having first and second ends. The first body portion defines a first chamber portion which extends between the first and second ends. The first chamber portion has a generally cylindrical cross-section adjacent the first end, and a generally conical cross-section adjacent the second end. The first body portion also has at least one inlet opening formed therein adjacent the first end. The inlet opening communicates with the generally cylindrical portion of the first chamber portion. Threads are formed at the second end of the first body portion.

This and other embodiments further include a vortex finder coupled to the first end of the first body portion. The vortex finder comprises a tubular portion extending into the first chamber portion along a central axis thereof, and an outlet opening which communicates with the first chamber portion via the tubular portion.

Certain embodiments further include a second body portion having first and second ends. The second body portion defines a second chamber portion which extends between the first and second ends of the second body portion. The second chamber portion has a generally conical cross-section having a greatest diameter at the first end substantially equal to a least diameter of the generally conical portion of the first chamber portion of the first body portion. The first end of the second body portion has threads for engaging the threads formed at the second end of the first body portion so as to secure the first and second body portions together. The second body portion also has threads formed at the second end thereof.

This and other embodiments further include an apex body which has first and second ends. The apex body defines a third chamber portion which extends between the first and second ends of the apex body. The third chamber portion has a generally conical cross-section having a greatest diameter at the first end substantially equal to a least diameter of the second chamber portion of the second body portion. The first end of the apex body has threads for engaging the threads formed at the second end of the second body portion so as to secure the second body portion and the apex body together.

Certain embodiments further include an apex received within a cavity formed in the second end of the apex body. The apex has first and second ends, and defines a fourth chamber portion extending between the first and second ends of the apex. This fourth chamber portion has a generally conical cross-section having a greatest diameter at the first end substantially equal to a least diameter of the third chamber portion of the apex body.

Preferred embodiments further include an apex holder for securing the apex within the cavity formed in the second end of the apex body. In certain embodiments, the apex holder has a plurality of threads on an exterior surface thereof. The threads operably engage mating threads formed within the cavity of the apex body to secure the apex within the apex body. More particularly, the apex holder has a bore extending therethrough. An inner diameter of the bore corresponds to at least a portion of an outer diameter of the apex such that the apex holder secures the apex within the cavity formed in the apex body when the threads of the apex holder engage the threads within the cavity of the apex body.

In preferred embodiments, the apex is formed of a molded ceramic material. One or more of the vortex finder, the upper body, the lower body, the apex body, and the apex holder are formed from a thermoplastic polymer, such as polytetrafluoroethylene. In a particularly preferred embodiment, the tubular portion of the vortex finder is formed of ceramic. One or more inserts formed of ceramic may also be provided in the inlet opening to protect the internal walls of the inlet opening.

In certain embodiments, at least one o-ring is disposed in at least one o-ring groove formed in an outer peripheral surface of the vortex finder or the first body portion. Another o-ring may be disposed in at least one additional o-ring groove formed in an outer peripheral surface of the apex holder or the second body portion.

### BRIEF DESCRIPTION OF THE DRAWINGS

The present disclosure will be described hereafter with reference to the drawing figures which are given as non-limiting examples only, in which:

FIG. 1 shows a perspective view of a cyclone assembly constructed in accordance with the present invention.

FIG. 2 shows a cross-sectional view of the cyclone assembly of FIG. 1.

FIG. 3 shows an exploded view of the cyclone assembly of FIGS. 1 and 2.

FIGS. 4a and 4b show front and top views, respectively, of a vortex finder of the cyclone assembly of FIGS. 1, 2 and 3.

FIGS. 5a and 5b show front and top views, respectively, of an upper body component of the cyclone assembly of FIGS. 1, 2 and 3.

FIGS. 6a and 6b show front and top views, respectively, of a lower body component of the cyclone assembly of FIGS. 1, 2 and 3.

FIGS. 7a and 7b show front and top views, respectively, of an apex body component of the cyclone assembly of FIGS. 1, 2 and 3.

FIGS. 8a and 8b show front and top views, respectively, of an apex insert of the cyclone assembly of FIGS. 1, 2 and 3.

FIGS. 9a, 9b and 9c show front, cross-sectional and top views, respectively, of an apex holder of the cyclone assembly of FIGS. 1, 2 and 3.

FIG. 10 shows a cross-sectional view of an alternative embodiment of a cyclone assembly constructed in accordance with the present invention.

FIGS. 11a and 11b show another alternative embodiment of a cyclone assembly constructed in accordance with the present invention.

### DETAILED DESCRIPTION OF THE DRAWINGS

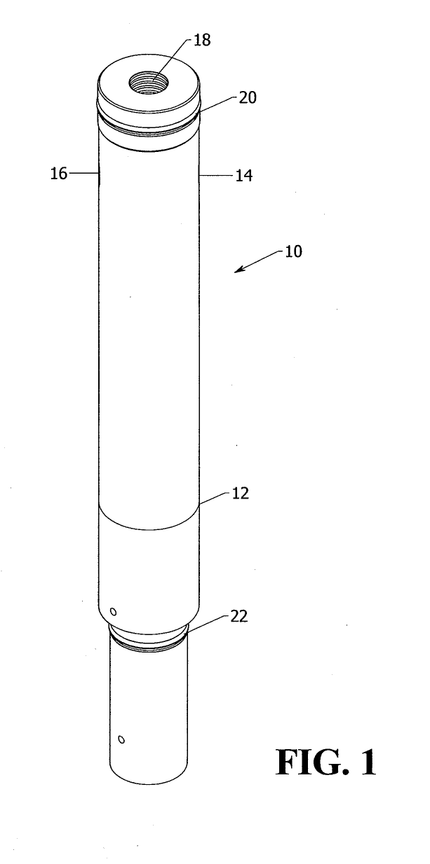

FIG. 1 shows a perspective view of a cyclone assembly 10 constructed in accordance with the present invention. Assembly 10 comprises a generally cylindrical, multi-component body 12, as will be described more fully below. Cyclone assembly 10 further comprises one or more inlet openings 14 and 16, which are more fully visible in other figures described below. Cyclone assembly 10 further comprises an outlet opening 18. As will be described in more detail below, a fluid flow containing particulate matter flows into assembly 10 through inlets 14 and 16. The particulate matter is separated from the fluid flow within cyclone assembly 10. Purified fluid flows out opening 18, and particulate matter is removed from an opening (not shown in FIG. 1) on an opposite end of cyclone assembly 10.

Cyclone assembly 10 further includes o-rings 20 and 22. In one embodiment, cyclone assembly 10 is one of a plurality of such assemblies mounted in a cartridge assembly which, in turn, is mounted within a tank or other enclosure which receives a flow of particulate containing fluid. O-rings 20 and 22 provide seals so that a pressurized flow of contaminated fluid may be provided adjacent the multiple cyclone assemblies. Fluid will enter each of the assemblies through one or more inlet openings (14 and 16 in the illustrated embodiment).

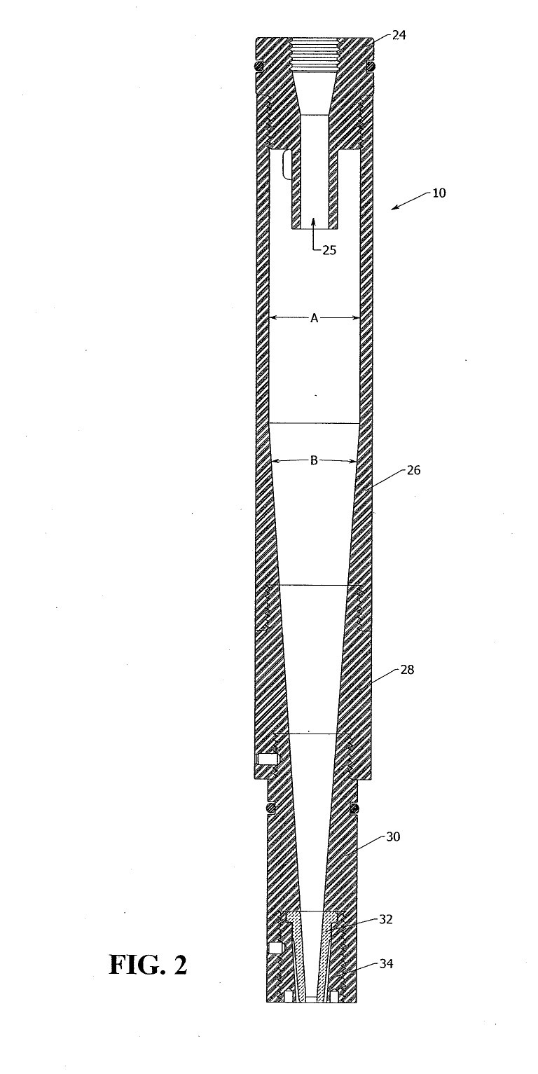

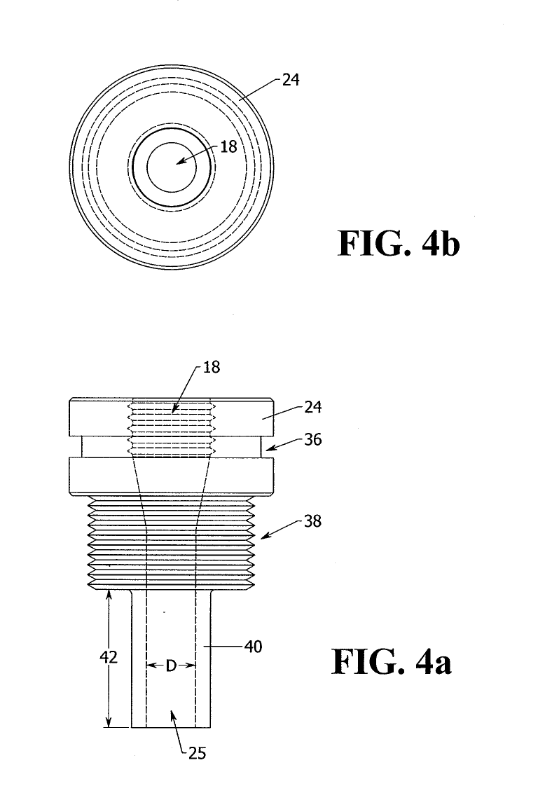

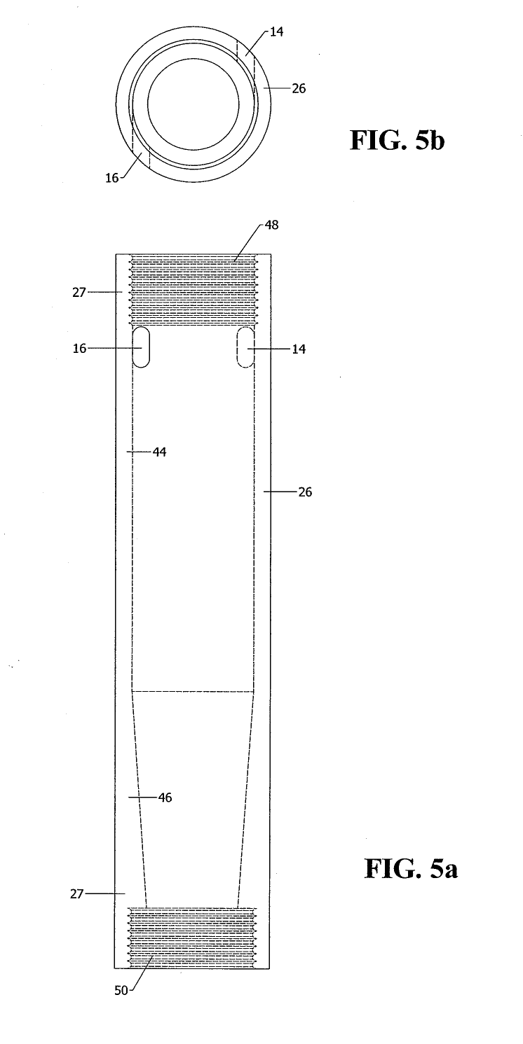

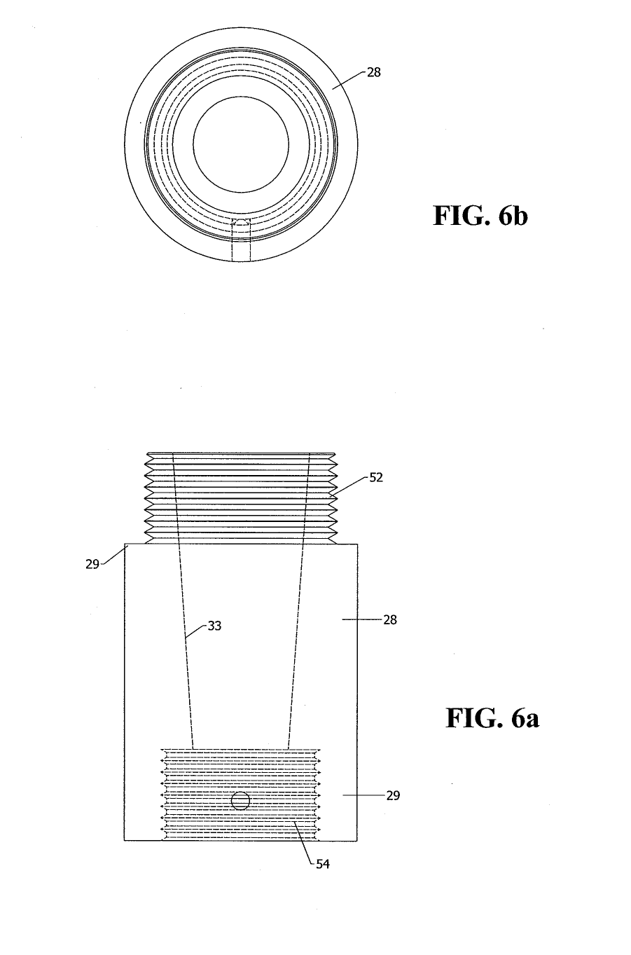

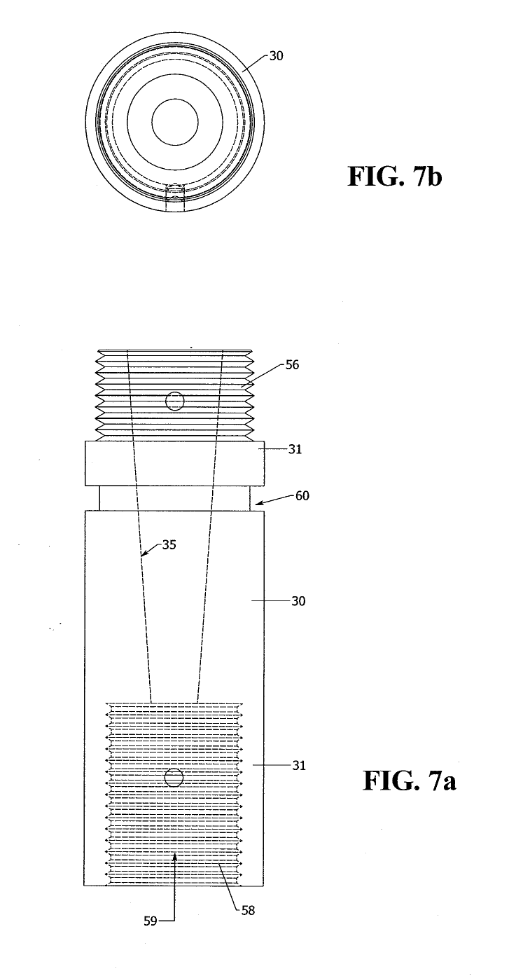

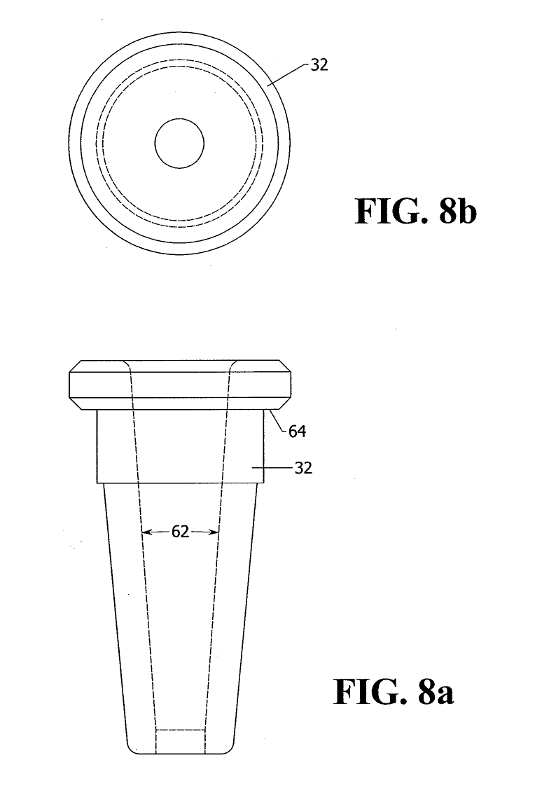

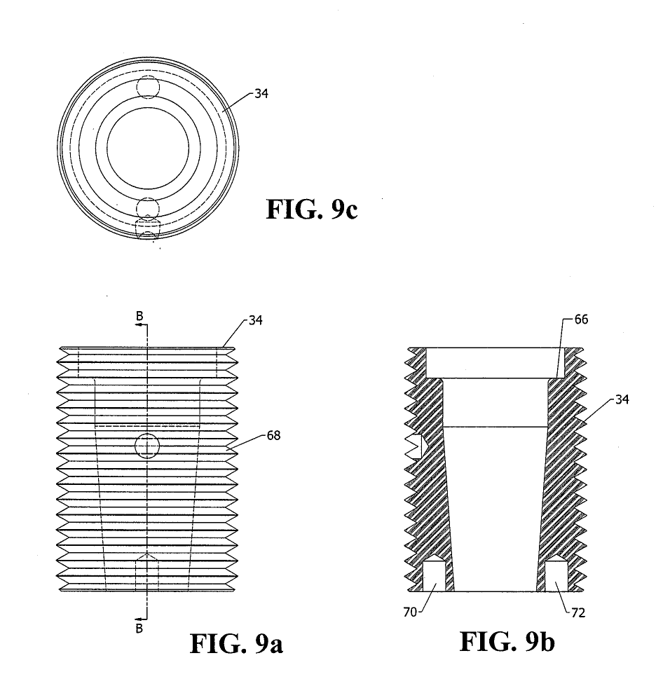

FIG. 2 shows a cross-sectional view of cyclone assembly 10. Visible in FIG. 2 are each of the plurality of components which make up cyclone assembly 10. The components of cyclone assembly 10 include: vortex finder 24 (see FIGS. 4a and 4b); upper body 26 (see FIGS. 5a and 5b); lower body 28 (see FIGS. 6a and 6b); apex body 30 (see FIGS. 7a and 7b); apex 32 (see FIGS. 8a and 8b); and apex holder 34 (see FIGS. 9a, 9b and 9c).

An inner diameter a of cyclone assembly 10, as measured across a cylindrical portion of upper body 26, may range from approximately ½ inch to approximately 4 inches. In a particularly preferred embodiment, the inner diameter of the cylinder proportion of upper body 26 is approximately 2 inches. As illustrated in FIG. 2a, the inner diameter of cyclone assembly 10 tapers in conical fashion from a lower portion B of upper body 26, continuing through lower body 28 and apex body 30, and through apex 32. The components of cyclone assembly 10 are, in the embodiment illustrated, molded or machined, and can be made of various materials, such as metals, plastics, and other moldable and/or machinable materials.

In the particular embodiment illustrated and described, vortex finder 24, upper body 26, lower body 28, apex body 30 and apex holder 34 are formed from Teflon® in a machining operation. Teflon® is a thermoplastic polymer having the generic name “polytetrafluoroethylene” (“PTFE”) available from E.I. du Pont de Nemours and Company (“Dupont”). PTFE is a white solid at room temperature and has a melting point of 327 degrees C. (621 degrees F.). It has a very low coefficient of friction and is not easily wetted by water-based or oil-based liquids. PTFE has a high corrosion resistance and is advantageous for use in handling highly corrosive and abrasive fluid streams. Apex 32 is formed of molded ceramic. This material is also particularly well-suited for use with a highly corrosive fluid flow containing highly abrasive particulate matter.

The various components of cyclone assembly 10 provide a “modular” construction which offers advantages in operation. Due to the modular construction, cyclone assembly 10 may be disassembled readily for cleaning and maintenance. Individual components of cyclone assembly 10 which may be more susceptible of wear than other components, may be more easily replaced for economical operation and service. Individual components may also be replaced to change the operating characteristics of cyclone assembly 10. For example, upper body 26 can be replaced with a similar component having an increased or reduced inner diameter. Vortex finder 24 may also be replaced with a comparable component having an increased length which results in inlet 25 extending farther below inlets 14 and 16. The length and inner diameter of vortex finder 24 are variables which affect the overall operation of cyclone assembly 10. The ability to readily replace vortex finder 24 with a similar part having different dimensions (i.e., length and inner diameter) allow for easy adjustment of operating characteristics. Apex 32 may also be readily interchanged to vary the length or inner diameter thereof, and to replace components worn by contact with particulate matter.

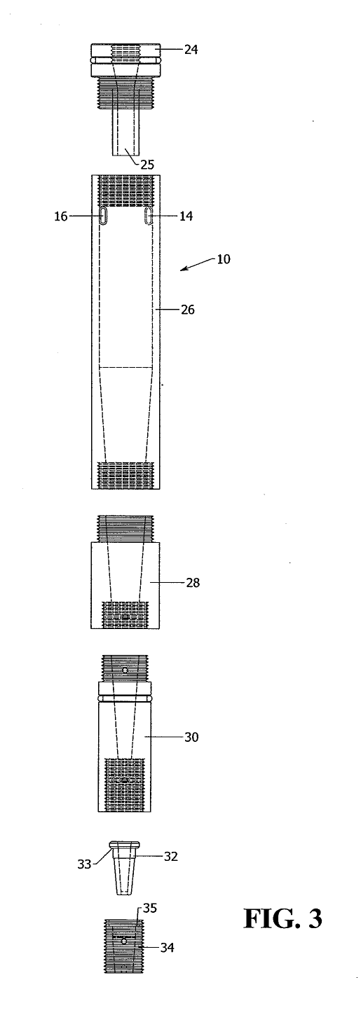

FIG. 3 shows an exploded view of the cyclone assembly 10 and illustrates the manner in which the components of cyclone assembly 10 are assembled. As illustrated, vortex finder 24, upper body 26, lower body 28, apex body 30 and apex holder 34 are secured, respectively, to one another by threaded connections. Apex 32 is secured within a cavity in apex body 30 by apex holder 34 by means of a shoulder 33 which interacts with a corresponding recessed shoulder 35 formed in apex holder 34. Thus, cyclone assembly 10 may be entirely disassembled by means of the threaded connections. This construction makes for easy disassembly for purposes of cleaning, maintenance and replacement of individual components.

FIGS. 4a and 4b show, respectively, front and top views, of vortex finder 24. Vortex finder 24 includes a groove 36 around a portion thereof for receiving o-ring 20 to form a seal with a surrounding surface. Vortex finder 24 further includes male threads 38 machined or molded therein to provide a means of connection to upper body 26. A cylindrical portion 40 extends from threads 38. A length 42 of portion 40 may be varied to position inlet 25 at a closer or further distance from the position of inlets 14 and 16. The length 42 and inner diameter d of portion 40 affect the operational characteristics of cyclone assembly 10.

Vortex finder 24 further includes outlet opening 18. In the embodiment illustrated, opening 18 is threaded so as to provide a secure connection for the overflow of fluid from cyclone assembly 10.

FIGS. 5a and 5b show, respectively, front and top views of upper body 26. As illustrated, upper body 26 is cylindrical in form, and includes a portion 44 having a cylindrical inner diameter and a portion 46 having a diameter which tapers in a decreasing manner to form a portion of a truncated cone. Female threads 48 and 50 are formed in opposing ends of upper body 26. Threads 48 receive threads 38 of vortex finder 24. Threads 50 receive threads 52 of lower body 28, described below.

Inlet openings 14 and 16 are formed in cylindrical portion 44 of upper body 26. Inlets 14 and 16 provide an inlet feed of fluid entering cyclone assembly 10. Inlet opening 14 and 16 are positioned tangentially of a center of upper body 26 such that when the inlet fluid feed enters inlet openings 14 and 16 under pressure, a circular flow is formed. That is, fluid flows in a circular motion around the inner diameter of upper body 26. The circular flow creates centrifugal forces which cause particulate matter to migrate to the inner walls of upper body 26. The conical shape of the inner diameter of portion 46 of upper body 26, and conical shapes of lower body 28, apex body 30 and apex 32, cause the particulate matter to further migrate toward apex 32 for removal. Fluid in the central portion of upper body 26 flows upwardly through inlet 25 of vortex finder 24 and outlet opening 18.

FIGS. 6a and 6b show front and top views, respectively, of lower body 28. In the illustrated embodiment, male threads 52 and female threads 54 are formed in opposing ends of lower body 28. Male threads 52 mate with female threads 50 of upper body 26 so as to secure lower body 28 to upper body 26. Female threads 54 receive male threads 56 (described below) of apex body 30 so as to secure apex body 30 to lower body 28.

FIGS. 7a and 7b show front and top views, respectively, of apex body 30. Apex body 30 includes male threads 56 which mate with female threads 54 of lower body 28 to secure apex body 30 to lower body 28. Apex body 30 further includes female threads 58 formed in the walls of a cavity 59 which receives apex 32 and apex holder 34. Apex body 30 further includes groove 60 which receives o-ring 22 for establishing a seal between apex body 30 and a surrounding surface.

FIGS. 8a and 8b show front and top views, respectively, of apex 32. In the preferred embodiment, apex 32 is formed of a molded ceramic material. Apex 32 includes a tapered conical inner diameter 62 which, together with the inner diameters of apex body 30, lower body 28 and portion 46 of upper body 26, form a portion of a cone. Apex 32 further includes a shoulder 64 which engages a recessed shoulder 66 of apex holder 34 (as described below) to secure apex 32 to apex body 30.

FIGS. 9a, 9b and 9c show front, cross-sectional and top views, respectively, of apex holder 34. An outer surface of apex holder 34 is provided with threads 68 which are received by female threads 58 of apex body 30. Apex 32 is positioned within an inner diameter of apex holder 34 such that shoulder 64 of apex 32 abuts shoulder 66 of apex holder 34. A pair of cylindrical bores 70 and 72 are provided in an end of apex holder 34 to provide a means by which apex holder 34 may be threaded into apex body 30.

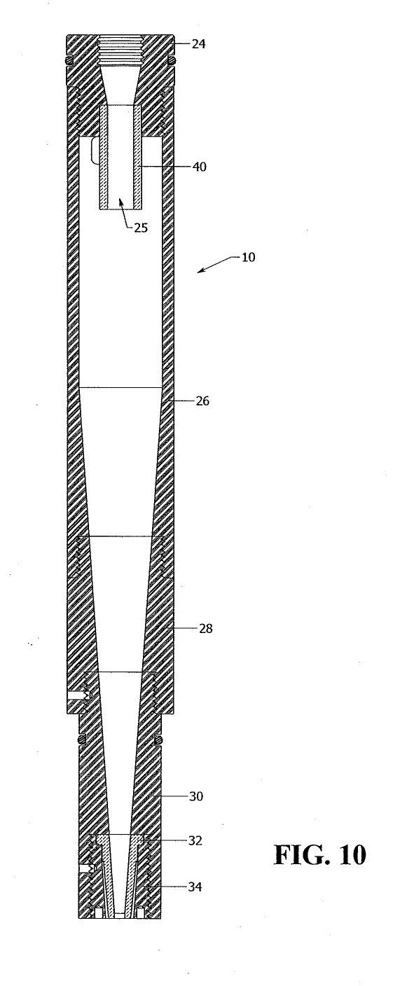

FIG. 10 shows a cross-sectional view of an alternative embodiment of a cyclone assembly 10′ constructed in accordance with the present invention. Cyclone assembly 10′ is similar to cyclone assembly 10 except for the construction of respective vortex finders 24 and 24′. In cyclone assembly 10′, vortex finder 24′ is provided with a ceramic vortex finder insert 40′ which extends from vortex finder 24′ into the cylindrical portion of the cyclone chamber. Ceramic vortex insert 40′ is superior in terms of wear resistance to the corresponding cylindrical portion 40 of vortex finder 24. Insert 40′ may also be replaced separately from the remainder of vortex finder 24′.

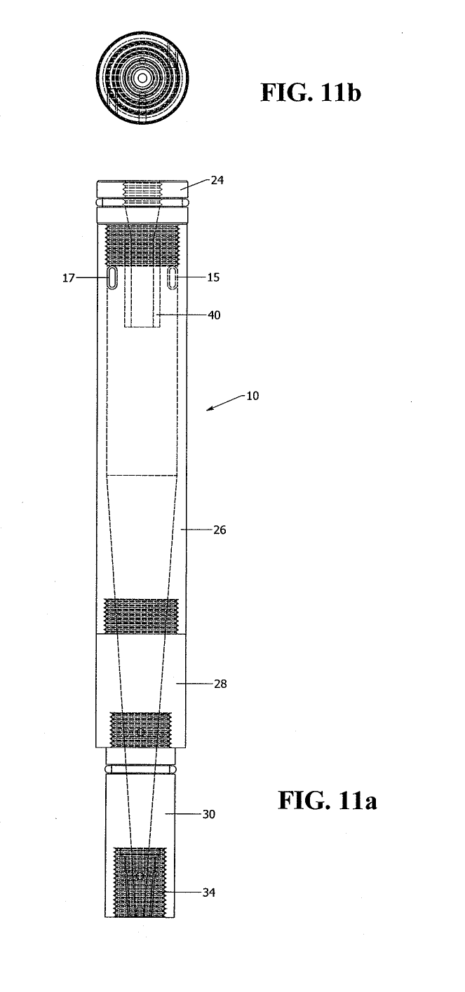

FIGS. 11a and 11b show another alternative embodiment of a cyclone assembly 10″ constructed in accordance with the present invention. Cyclone assembly 10″ is similar in most respects to cyclone assembly 10′ of FIG. 10. However, in cyclone assembly 10″, ceramic feed inlet inserts 15 and 17 are provided in fluid inlet openings 14 and 16, respectively. Such inserts protect the internal walls of the fluid inlet openings from corrosion and abrasion which might otherwise be caused by the contaminated fluid stream.

Corresponding reference characters indicate corresponding parts throughout the several views. The exemplifications set out herein illustrate preferred embodiments of the invention, and such exemplifications are not to be construed as limiting the scope of the invention in any manner.

Although the present disclosure has been described with reference to particular means, materials and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A cyclone assembly, comprising:
a first body portion having first and second ends, said first body portion defining a chamber extending between said first and second ends, said chamber having a generally cylindrical portion adjacent the first end and a generally conical portion adjacent the second end, said first body portion having at least one inlet opening formed therein adjacent said first end, said inlet opening communicating with the generally cylindrical portion of the chamber;
a vortex finder coupled to the first end of the first body portion, said vortex finder having a tube extending into the chamber along a central axis thereof and an outlet opening communicating with the chamber via the tube;
a second body portion having first and second ends, said second body portion defining a chamber extending between said first and second ends, said chamber having a generally conical cross-section and a greatest diameter at said first end equal to a least diameter of the generally conical portion of the chamber of the first body portion, said first end of the second body portion having threads for engagement with mating threads formed at the second end of the first body portion so as to secure the first and second body portions together;
an apex body having first and second ends, said apex body defining a third chamber extending between the first and second ends, said chamber having a generally conical cross-section and a greatest diameter at said first end equal to a least diameter of the conical chamber of the second body portion, said first end of the apex body having threads for engagement with mating threads formed at the second end of the second body portion so as to secure the second body portion and the apex body together;
an apex received within a cavity formed in the second end of the apex body, said apex having first and second ends, and said apex defining a chamber extending between said first and second ends, said chamber having a generally conical cross-section and a greatest diameter at said first end equal to a least diameter of the generally conical chamber of the apex body; and
an apex holder for securing the apex within the cavity formed in the second end of the apex body.

2. The cyclone assembly of claim 1, wherein said apex holder comprises a plurality of threads on an exterior surface thereof, said threads operably engaging mating threads formed within the cavity of the apex body.

3. The cyclone assembly of claim 2, wherein said apex holder has a bore extending therethrough, an inner diameter of said bore corresponding to at least a portion of an outer diameter of the apex such that said apex holder secures the apex within the cavity formed in the apex body when the threads of the apex holder engage the threads within the cavity of the apex body.

4. The cyclone assembly of claim 1, wherein said apex is formed of molded ceramic material.

5. The cyclone assembly of claim 1, wherein one or more of said vortex finder, said upper body, said lower body, said apex body and said apex holder are formed from a thermoplastic polymer.

6. The cyclone assembly of claim 5, wherein said thermoplastic polymer is polytetrafluoroethylene.

7. The cyclone assembly of claim 1, wherein the tubular portion of the vortex finder is formed of ceramic.

8. The cyclone assembly of claim 1, wherein said inlet opening of said first body portion comprises an insert formed of ceramic to protect the internal walls of the inlet opening.

9. The cyclone assembly of claim 1, further comprising at least one o-ring disposed in at least one o-ring groove formed in an outer peripheral surface of the vortex finder or the first body portion.

10. The groove of assembly of claim 1, further comprising at least one o-ring disposed in at least one o-ring groove formed in an outer peripheral surface of said apex holder or said second body portion.

11. A modular cyclone assembly, comprising:
a modular body formed from a plurality of releasably coupled body portions, said modular body having first and second ends, and defining a chamber extending between said first and second ends, said modular body including:
1) a first body portion having first and second ends, and defining a first chamber portion extending between the first and second ends, at least a portion of said first chamber portion having a generally cylindrical cross-section; and
2) one or more additional body portions releasably coupled to the second end of the first body portion, said additional body portions defining a second chamber portion communicating with the first chamber portion, at least a portion of said second chamber portion having a generally conical cross-section;
a vortex finder releasably coupled to the first end of the modular body and extending into the generally cylindrical portion of the first chamber portion;
an apex releasably coupled to the second end of the modular body, said apex defining a generally conical bore therethrough and being in communication with the second chamber portion to effectively extend the generally conical cross-section portion of the second chamber to the second end of the modular body;
an inlet formed in the modular body and communicating with the generally cylindrical portion of the first chamber portion; and
an outlet extending through a tubular portion of the vortex finder.

12. The modular cyclone assembly of claim 11, wherein the modular body is formed from three body portions.

13. The modular cyclone assembly of claim 12, wherein each of said three body portions is provided with threads on at least one end thereof so that said body portions can be releasably and serially coupled.

14. The modular cyclone assembly of claim 13, wherein a cavity is formed in the body portion at the second end of the modular body for receiving the apex, and further comprising an apex holder for releasably coupling the apex to the second end of the modular body.

15. The modular cyclone assembly of claim 14, wherein said apex holder comprises a threaded sleeve.

16. The modular cyclone assembly of claim 11, wherein a first portion of said first chamber portion defined by the first body portion has a generally cylindrical cross-section and a second portion of said first chamber portion has a generally conical cross-section.

17. The modular cyclone assembly of claim 11, wherein said modular body portions are formed from a thermoplastic polymer.

18. The modular cyclone assembly of claim 17, wherein said thermoplastic polymer is polytetrafluoroethylene.

19. The modular cyclone assembly of claim 11, wherein said apex is formed of molded ceramic material.

20. The modular cyclone assembly of claim 11, wherein said tubular portion of the vortex finder is formed from a ceramic material.
